(19) United States
(12) Patent Application Publication
(10) Pub. No.: US 2016/0356442 A1
(43) Pub. Date: Dec. 8, 2016

(54) LED CANDLE ELEMENT AND MECHANICAL CANDLE

(71) Applicants: Pedro F. GARCIA, Sandy Springs, GA (US); David D. GARCIA, Duluth, GA (US)

(72) Inventors: Pedro F. GARCIA, Sandy Springs, GA (US); David D. GARCIA, Duluth, GA (US)

(73) Assignee: GARCIA GROUP, INC., Atlanta, GA (US)

(21) Appl. No.: 14/818,752

(22) Filed: Aug. 5, 2015

Related U.S. Application Data
(60) Provisional application No. 62/170,362, filed on Jun. 3, 2015.

(51) Int. Cl. F21S 6/00; F21V 23/04; F21S 10/04; F21L 4/00

(52) U.S. Cl. CPC F21S 6/001; F21L 4/00; F21V 23/04; F21S 10/043; F21Y 2101/02

(57) ABSTRACT

An artificial candle including an elongate slender tube, an elongate slender rod, and a light assembly. The light assembly is inserted within the elongate slender tube and the elongate slender rod is inserted within the elongate slender tube and maintains positioning of the light assembly therein.

### CROSS-REFERENCE TO RELATED APPLICATION

This application is a nonprovisional of U.S. Provisional Patent Application Ser. No. 62/170,362 filed Jun. 3, 2015, the entirety of which is hereby incorporated herein by reference for all purposes.

### BACKGROUND OF THE INVENTION

It has been well known for decades that the glow and aura of candlelight can be both pleasant and therapeutic. As a result, many establishments have incorporated the use of candles to enhance the ambiance and setting for their customers and guests. Candles are also widely used in homes and churches. In addition, candles are often used for relaxation and stress reduction. Consequently, candles are enormously popular and widely utilized.

One style of candle that has been popular for many years is the elongated candle. This candle is generally elongated and has a wick extending at its distal end. Traditionally, the candle is held in an upright position by frictionally engaging the proximal end of the candle within a candle holder. In use, as the candle burns, the wax surrounding the wick melts and evaporates and thus the length of the candle shrinks. To maintain a consistently level flame and the appearance of an ever-burning non-shrinking candle, a spring-loaded candle sleeve was invented.

The spring-loaded candle sleeve typically is constructed of an elongated rigid outer shell forming a cavity therein for receiving a candle. As such, the candle sleeve is shaped and dimensioned substantially similar to a candle. In use, the candle sleeve is secured in the upright position by inserting the bottom of the candle sleeve into any one of many known candle holders.

A spring-loaded insert typically is positioned concentrically within the candle sleeve and extends generally the length thereof for urging the candle up to an aperture formed at the upper portion of the candle sleeve, wherein the wick of the candle extends therethrough. Consequently, as the candle burns and shrinks longitudinally due to the evaporation and consumption of the wax, the spring-loaded insert continuously urges the candle upwardly toward the aperture. Thus, a consistent horizontally-positioned flame results. More specifically, as viewed by an observer, the candle sleeve gives the appearance of an ever-burning, non-shrinking candle.

The spring-loaded candle sleeve alone, however, was found disadvantageous. For instance, because of its size, shape and functionality, the prior art candle sleeve is reasonably incapable of being formed into various configurations and is further limited as to its degree of possible ornamentation. Unfortunately, candle-holding bases are often unappealing and fail to provide a decorative means for encasing the entire candle sleeve.

Thus, in the recent past, a new and improved decorative candle holder for a spring-loaded candle sleeve was developed that provides a decorative means for encasing the entire candle sleeve. That device, as shown and described in U.S. Pat. No. 6,270,341, comprised a holder in the form of a decorative cover forming a cavity therethrough, wherein the cover has an upper aperture and a lower aperture. The lower aperture and the cavity are dimensioned for receiving the candle sleeve therein. In the preferred form, the upper aperture has a diameter slightly smaller than the diameter of the sleeve such that the tip of the sleeve rests within the upper aperture, but does not extend therethrough. The bottom of the sleeve is frictionally secured within the lower aperture, preferably by a flexible ring that is slidably engaged with the sleeve and is of sufficient thickness to snugly fit radially between the bottom of the sleeve and the walls of the lower aperture. Optionally, feet or friction material can be attached to the bottom of the holder to help support the holder in an upright position.

In using the device of U.S. Pat. No. 6,270,341, a candle is inserted within the sleeve with the wick of the candle extending to the top of the sleeve. With the sleeve inserted into the holder, the wick extends out of the holder through the upper aperture. As the candle burns and shrinks due to evaporation of the wax surrounding the flame, the spring-loaded sleeve urges the candle up against the upper aperture. Thus, a consistently horizontally level flame is produced. When it is necessary to replace the candle, the bottom of the sleeve and the spring-loaded insert are removed, another candle is inserted into the sleeve and the insert is replaced. The bottom of the sleeve, in the preferred form, extends slightly below the holder to allow replacement of the candle without removing the entire sleeve from the holder.

There are a good number of such candle devices sold and installed widely. However, in recent years there has been growing concern about the inherent fire hazard associated with using real candles with real flames. There have been efforts to develop electric candles, using incandescent or LED lamps. Unfortunately, such electric candles are generally incompatible with the candle sleeve devices described above.

### SUMMARY OF THE INVENTION

Briefly described, in an example form the present invention comprises an artificial candle lamp for use in a mechanical candle of the type having an elongate slender tube with an upper opening and a lower opening. Preferably, the artificial candle lamp includes an assembly configured and adapted to be inserted through the lower opening of the elongate slender tube and to be received and retained therein, with a portion but not all of the assembly protruding through the upper opening of the elongate slender tube. Also preferably, the assembly includes a housing, an LED bulb, an electronic circuit for driving the LED bulb and adapted for driving the LED bulb in a non-constant manner to simulate the flickering of a burning wax candle, and one or more batteries for powering the LED bulb and/or the electronic circuit.

Preferably, the artificial candle lamp further includes a candle flame-shaped tip covering the LED bulb. Optionally, the tip is clear or translucent. Also optionally, the tip comprises a resilient polymer.

Optionally, a screw on cap is provided for completing the electronic circuit and/or powering the electronic circuit on or off to function as a switch. Preferably, the one or more batteries comprise three button-shaped batteries operating in series.

In one optional form, the electronic circuit is adapted to drive the LED bulb in such a manner so as to vary the output color of the LED bulb over time.

In another preferred form, the present invention comprises an artificial candle including a mechanical candle housing and an artificial candle lamp. The mechanical candle housing preferably includes an elongate slender tube with an upper opening, a lower opening, and a closure removably fitted at the lower opening. The artificial candle lamp preferably includes an assembly configured and adapted to be inserted through the lower opening of the elongate slender tube and to be received and retained therein, with a portion but not all of the assembly protruding through the upper opening of the elongate slender tube, the assembly comprising a housing, an LED bulb, an electronic circuit for driving the LED bulb and adapted for driving the LED bulb in a non-constant manner to simulate the flickering of a burning wax candle, and one or more batteries for powering the LED bulb and/or the electronic circuit.

Optionally, a pull-tab activation feature may be incorporated into the assembly.

### BRIEF DESCRIPTION OF THE DRAWING FIGURES

FIG. 1 is a side view of an artificial candle according to an example embodiment of the present invention.

FIG. 2 is a perspective view of a portion of the artificial candle of FIG. 1.

FIG. 3 is a plan view of the artificial candle of FIG. 1, showing the candle disassembled.

FIGS. 4-5 show perspective end views of an elongate slender tube of the artificial candle of FIG. 1.

FIG. 6 is a perspective end view of a portion of an assembly of the artificial candle of FIG. 3.

FIG. 7 is an assembly view of a portion of the assembly of the artificial candle of FIG. 1.

FIG. 8 is a perspective view of a portion of the assembly of FIG. 7.

FIG. 9 is a perspective view of a light assembly according to another example embodiment of the present invention.

FIG. 10 is a plan view of a schematic of a wiring circuit of the light assembly of FIG. 9.

### DESCRIPTION OF EXAMPLE EMBODIMENTS

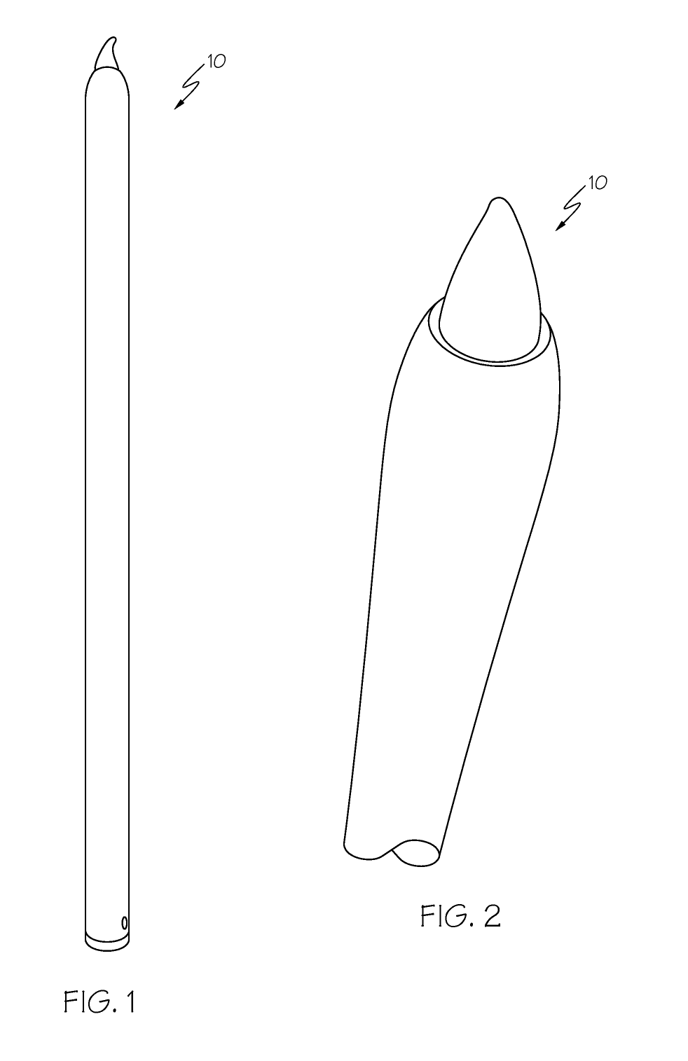

With reference now to the drawing figures, wherein like reference numbers represent corresponding parts throughout the several views, FIGS. 1-8 show an artificial candle 10 according to an example embodiment of the present invention. In example forms, the artificial candle 10 generally comprises an elongate slender tube or outer housing member 20 and an assembly configured and adapted to be received within the elongate slender tube 20. According to some example forms, the assembly comprises an elongate slender rod 40 and a light assembly 60.

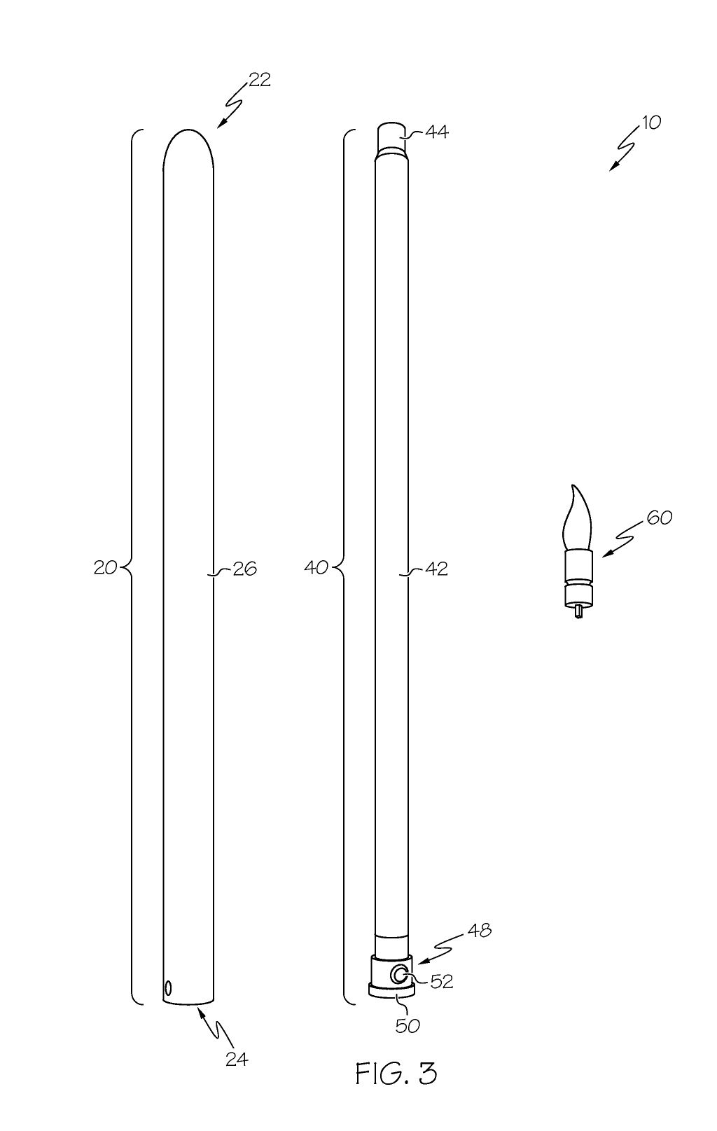

FIG. 3 shows the artificial candle 10 disassembled into several components, for example, the elongate slender tube 20, the elongate slender rod 40, and the light assembly 60. In example forms, the elongate slender tube 20 generally comprises a cylindrical or tube-like body 26 comprising a first end 22 and a second end 24 generally opposite thereto. The elongate slender rod 40 generally comprises a main body portion 42 having a spring-biased rod 44 movably mounted therein at a first end thereof and a base coupling 48 mounted at a second end thereof. The base coupling 48 generally comprises a lower knurled gripping portion 50 and one or more spring-biased indentions 52.

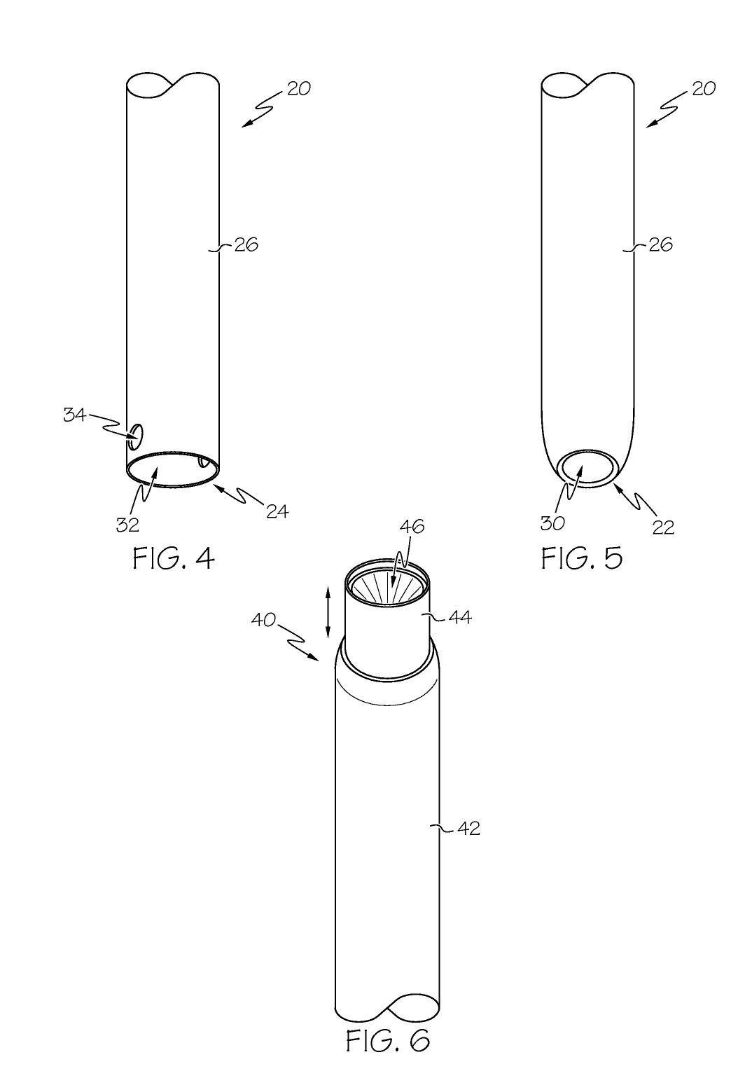

FIGS. 4-5 show further details of the elongate slender tube 20. For example, the second end 24 of the tube 20 comprises an opening 32 and the first end 22 comprises an opening 30. Preferably, the openings 30, 32 formed at the ends thereof extend through the ends of the tube 20 and throughout the body 26 such that an opening is provided through the entire tube 20. According to one form, the first end 22 of the tube 20 is generally tapered such that the opening 30 is at least partially smaller than the opening 32 of the second end 24. Furthermore, the second end 24 comprises one or more openings formed along the periphery of the tube 20 whereby one or more of the spring-biased indentions 52 provided at the base coupling 48 can interengage therewith when the elongate slender rod 40 is inserted within the tube 20. As depicted in FIG. 6, the spring-biased rod 44 of the first end of the rod 40 generally extends from the body portion 42 and is movable relative thereto (see direction arrows). Typically, the diameter of the spring-biased rod 44 is generally smaller than the diameter of the body portion 42, and the diameter of the body portion 42 is generally smaller than the diameter of the opening 32 of the tube 20. In some example forms, a portion of the spring-biased rod is generally countersunk to comprise a recessed area 46.

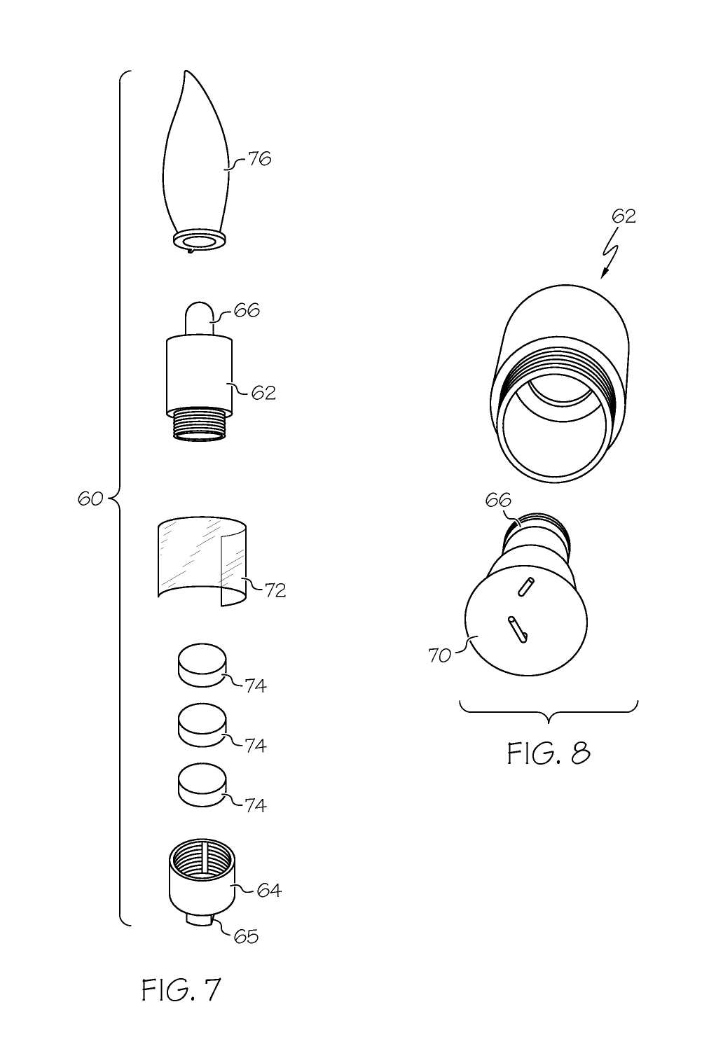

As depicted in FIGS. 7-8, the light assembly 60 generally comprises a plurality of components including a first housing portion 62, a second housing portion 64, an LED light 66, an electronic circuit 70, a shielding sleeve or band 72, one or more batteries 74, and a candle flame-shaped tip 76. The first housing portion 62 generally comprises an opening extending therethrough and comprises an inner ring positioned therein for seating against a portion of the electronic circuit 70 (or housing thereof) (see FIG. 8). Thus, with the LED bulb 66 mounted to the electronic circuit 70, the bulb 66 is inserted within the opening of the first housing portion 62 whereby the LED bulb 66 generally extends therefrom (see FIG. 7). In example forms, an end of the first housing portion 62 comprises a male threaded portion for removable interengagement with a female threaded portion of the second housing portion 64. Preferably, the first housing portion comprises ample space such that one or more of the batteries 74 are capable of being fitted therein and positioned against a portion of the electronic circuit 70. Optionally, the electronic circuit 70 is adapted to drive the LED bulb in such a manner so as to vary the output color of the bulb over time, for example, to adjust its color and/or to provide a simulated flicker similar to a candle.

According to one example form, the first housing portion 62 is generally sized and shaped to receive three LR41 button cell batteries. According to some example forms, the shielding sleeve 72 is inserted within the first housing portion to line the interior periphery portion thereof, and the batteries 74 are fitted within the first housing portion 62 and within the shield 72. Thus, the shield prevents the conductive batteries from contacting the conductive housing portion 62, which would cause the circuit to short out. In example forms, the second housing portion 64 preferably removably engages the threaded male end of the first housing portion 62, for example, to contain the batteries and optional shield 72 therein. Preferably, twisting the second housing portion provides for turning on and off the LED light, for example, by either completing or disconnecting the circuit. Typically, the second housing portion 64 comprises a conductive indention extending from an internal portion thereof for contacting one of the batteries within the first housing portion 62 to complete the circuit. Thus, with one of the batteries contacting a portion of the electronic circuit 70, and with one of the batteries contacting the conductive indention of the second housing portion, the circuit is completed and energy from the batteries is transferred to the circuit to power the LED light 66. Preferably, the threaded portions of the first and second housing portions is sufficient such that enough rotation of one of the housing portions relative to the other will either cause contact therebetween (e.g., completing the circuit) or will remove the contact therebetween. As depicted in FIG. 7, an end portion of the second housing portion 64 can comprise a stem or rod-like projection 65 for engaging the recessed area 46 of the spring-biased rod 44.

Optionally, a candle flame-shaped tip 76 is provided for covering the LED bulb 66 to provide for simulating the look and feel of a wax burning candle flame. According to some forms, the flame-shaped tip 76 is formed from a resilient polymer. Further optional, a the light assembly 60 may be configured such that an additional switch incorporated within a portion of the tube 20, rod 40 or other portions of the artificial candle such that a user can simply press a button or flip a switch to power the electronic circuit on or off, for example, instead of having to remove the light assembly 60 from the tube 20 to turn on or off the electronic circuit.

In use, the light assembly is turned on by rotating the second housing portion 64 is a clockwise manner relative to the first housing portion to complete the circuit and cause light to be emitted from the LED bulb 66. The light assembly 60 is then inserted into the opening 32 of the second end 24 of the tube 20 and then moved therein until abutting and at least partially extending from the opening 30 of the first end 22. Preferably, the LED bulb 66 is inserted within the opening 32 first such that the bulb 66 or a portion of the sight assembly (e.g., the flame-shaped tip) is at least partially extending from the opening 30. Preferably, the opening 30 of the first end 22 is at least slightly smaller than the housing portions 62, 64 of the light assembly 60, thereby preventing the light assembly 60 from escaping from the opening 30. Next, the elongate slender rod 40 is inserted within the opening 32 of the second end 24 of the tube 20 and moved therein until the one or more intents 52 of the base portion engage the one or more openings 34 of the tube 20 (thereby causing interengagement between the rod 40 and tube 20). Preferably, according to some example forms, the spring-biased rod 44 provides for maintaining the light assembly at the first end 22 of the tube 20. The artificial candle 10 can then be used as desired. When it is desired to turn off the light assembly 60, the rod 40 is removed from the tube 20 and the light assembly 60 is removed from the tube 20. The second housing portion 64 can then be rotated in a counter-clockwise direction relative to the first housing portion 62 such that the circuit is not longer completed and the LED bulb 66 is not receiving power from the one or more batteries 74.

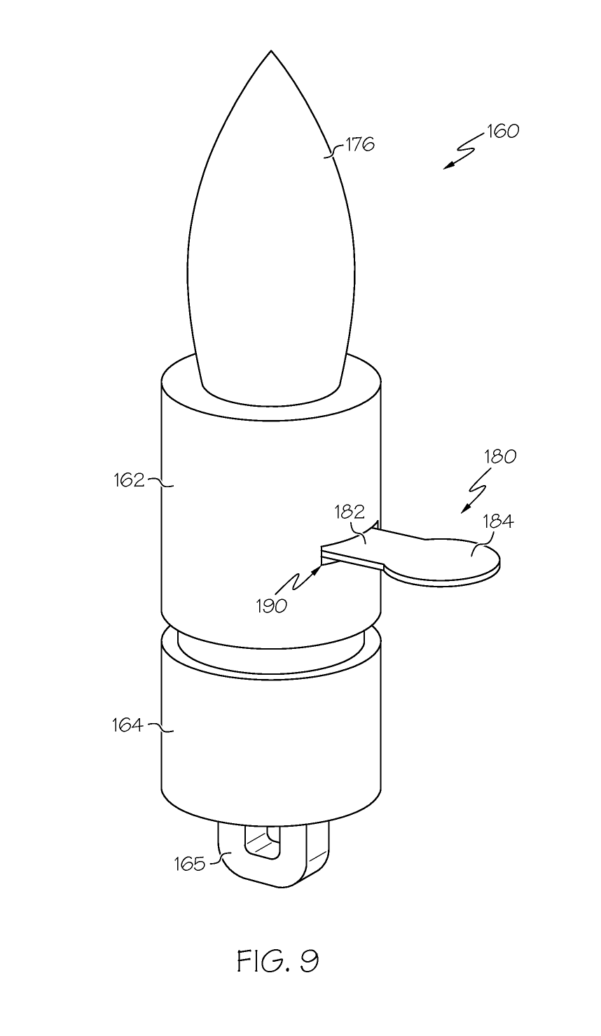

Optionally, according to additional example embodiments of the present invention, a pull-tab activation feature may be incorporated into the light assembly, for example, to activate the light so that the batteries can begin providing power to the electronic circuit and thus to the LED light. FIG. 9 shows a light assembly 160 comprising a pull-tab 180 inserted between one of the batteries and the electronic circuit 70 (see FIG. 8). As shown, the light assembly 160 is substantially similar to the light assembly 60 as described above, which comprises first and second housing portions 162, 164, a projection 165, and a flame-shaped tip 176 covering the LED light (unshown). According to example forms, an opening or slot 190 is formed on an outside periphery portion of the first housing portion 162 and extends therethrough to where the batteries are positioned. The pull-tab 180 generally comprises a body portion 182 and a grasping portion 184, and the body portion 182 is generally inserted within the slot 190 such that it is sandwiched between one of the batteries and the electronic circuit. Thus, the body portion 182 acts as an insulator and prevents electrical current from the batteries from passing to the electronic circuit, thereby ensuring that substantially no energy is expended from the batteries until a user desires to activate the light assembly 160 by removing the pull tab 180 from the light assembly 160. Preferably, the size and shape of the pull tab 180 including the body portion 182 and the grasping portion 184 can be chosen as desired. According to some forms, the pull tab is a generally flat, elongate strip-like element comprising a relatively uniform body portion 182 and a radiused grasping portion 184. In some example forms, the grasping portion 184 is generally sized and shaped to provide an area that can be easily grasped and removed by a user.

In typical example embodiments, the pull tab 180 is generally assembled with the light assembly 160 during the manufacture thereof, and the pull tab then remains sandwiched between one of the batteries and the electronic circuit until it is desired to activate the light assembly. In some example forms, the second housing portion 164 is generally tightened sufficiently while the pull tab 180 is present so that the only action required to provide for lighting the LED light is removal of the pull tab 180. Optionally, the second housing portion 164 may be slightly unscrewed (e.g., similar to the light assembly 60) such that the LED light does not turn on when the pull tab 180 is removed, thus still requiring the second housing portion 164 to be tightened with the first housing portion 162. In example forms, the pull tab 180 is generally formed from an insulative material including rubber, plastic, or other non-conductive materials.

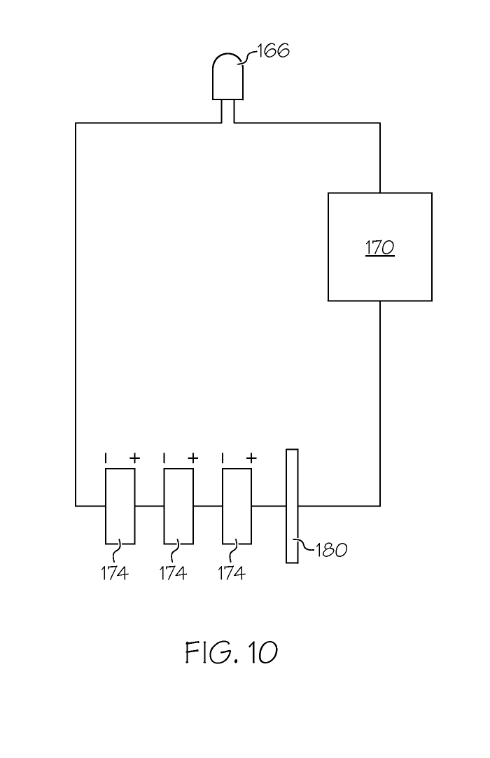

FIG. 10 shows an example schematic of the circuit provided by the light assembly 160. As shown, the components (e.g., LED light 166, circuit 170, and batteries 174) are generally wired in series and the pull tab is positioned between one of the batteries 174 and the circuit 170. Thus, the pull tab 180 prohibits electrical current from flowing through the entirety of the circuit when inserted between one of the batteries 174 and the electronic circuit 170, and wherein removal of the pull tab 180 enables the electrical current to flow throughout the circuit such that the LED light is powered. Optionally, the components can be configured such that the circuit is wired in parallel, or may be wired or positioned as desired to provide connectivity therebetween. Likewise, the pull tab can be provided to function to prevent contact between one or more of the batteries and the electronic circuit and/or LED light.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. An artificial candle lamp for use in a mechanical candle of the type having an elongate slender tube with an upper opening and a lower opening, the artificial candle lamp comprising:
an assembly configured and adapted to be inserted through the lower opening of the elongate slender tube and to be received and retained therein, with a portion but not all of the assembly protruding through the upper opening of the elongate slender tube, the assembly comprising a housing, an LED bulb, an electronic circuit for driving the LED bulb and adapted for driving the LED bulb in a non-constant manner to simulate the flickering of a burning wax candle, and one or more batteries for powering the LED bulb and/or the electronic circuit.

2. An artificial candle lamp as claimed in claim 1 further comprising a candle flame-shaped tip covering the LED bulb.

3. An artificial candle lamp as claimed in claim 2 wherein the tip is clear or translucent.

4. An artificial candle lamp as claimed in claim 2 wherein the tip comprises a resilient polymer.

5. An artificial candle lamp as claimed in claim 1 further comprising a screw-on cap for completing the electronic circuit and/or powering the electronic circuit on or off to function as a switch.

6. An artificial candle lamp as claimed in claim 1 wherein the one or more batteries comprise three button-shaped batteries.

7. An artificial candle lamp as claimed in claim 1 wherein the electronic circuit is adapted to drive the LED bulb in such a manner so as to vary the output color of the LED bulb over time.

8. An artificial candle lamp as claimed in claim 1, further comprising a slot formed through at least a portion of the housing for receiving a pull tab, the pull tab being sandwiched between the one or more batteries and the LED bulb and/or electronic circuit.

9. An artificial candle comprising:
a mechanical candle housing comprising an elongate slender tube with an upper opening, a lower opening, and a closure removably fitted at the lower opening;
an artificial candle lamp comprising an assembly configured and adapted to be inserted through the lower opening of the elongate slender tube and to be received and retained therein, with a portion but not all of the assembly protruding through the upper opening of the elongate slender tube, the assembly comprising a housing, an LED bulb, an electronic circuit for driving the LED bulb and adapted for driving the LED bulb in a non-constant manner to simulate the flickering of a burning wax candle, and one or more batteries for powering the LED bulb and/or the electronic circuit.

10. An artificial candle lamp as claimed in claim 9, further comprising a slot formed through at least a portion of the housing for receiving a pull tab, the pull tab being sandwiched between the one or more batteries and the LED bulb and/or electronic circuit.
